(19) United States
(12) Patent Application Publication
(10) Pub. No.: US 2013/0035866 A1
(43) Pub. Date: Feb. 7, 2013

(54) INSTRUMENT AND METHOD FOR ACQUIRING SIGNALS AND IMAGES RELATING TO THE GASTROINTESTINAL TRACT

(71) Applicants: Fabiano Carlos Paixão, Sao Judas Tadeu (BR); Jose Ricardo de Arruda Miranda, Botucatu (BR)

(72) Inventors: Fabiano Carlos Paixão, Sao Judas Tadeu (BR); Jose Ricardo de Arruda Miranda, Botucatu (BR)

(21) Appl. No.: 13/580,644

(22) PCT Filed: Feb. 22, 2011
(86) PCT No.: PCT/BR2011/000045

§ 371 Date: Oct. 4, 2012

(30) Foreign Application Priority Data
Feb. 22, 2010 (BR) PI 1000419-0

(51) Int. Cl. G06F 17/18

(52) U.S. Cl. 702/19

(57) ABSTRACT

This invention relates to an apparatus and method for improving detection by equipment used to detect magnetic susceptibility. The advantages provided are related to different factors, such as reduced instrumentation cost, performance in terms of stability and sensitivity, etc. The devices may be used, for example, to detect magnetic tracers and markers in the gastrointestinal tract of animals and humans. They can be used in research and/or for diagnostic purposes using information related to a variety of parameters of the gastrointestinal tract, such as, pharyngeal and oesophageal transit time, gastric emptying and motility, colonic motility, inter alia.

### FIELD OF THE INVENTION

The present invention relates to a device for the measuring of magnetic biosusceptibility. More specifically, the invention relates to an instrument to detect a magnetic field and/or measure biosusceptibility for use in medical diagnosis and research of parameters related to the gastrointestinal tract, such parameters as gastrointestinal transit time, esophageal and pharyngeal clearance time and time of gastric emptying, among other things.

### STATE OF THE ART

The magnetic susceptibility of a material or substance describes its response to a magnetic field applied to it. That property may be used to measure variations within the tissues of the human body (e.g., measure the concentration of iron in the liver), as well as to measure and/or identify the presence and/or movement of one or more magnetic markers or metallic foreign objects within the tissues and/or organs.

The first study of gastric activity involving biomagnetic devices was carried out by Wenger et al. in the 1950s decade. A magnetometer (Waugh magnetometer type W-2) and a small magnetic marker (permanent alnico 5 magnet with polystyrene coating) were used to study gastric motility and time of transit. In 1977 Benmair et al. developed a technique designated “Alternating Current Biosusceptometry” and employed it to measure gastric motility and time of gastric transit. In 1977 Benmair et al. developed a techniques denominated “Alternating Current Biosusceptometry” and employed it to measure gastric motility and time of gastrointestinal transit using magnet tracer. Magnetic markers are constituted of a magnetic source point of small dimensions (1-10 mm) and magnetic tracers are constituted of a distributed magnetic source (e.g., ferromagnetic powder distributed in a test food). The Benmair group developed a device made up of an alternating current (50 Hz) magnetic excitation coil and two detection coils connected in a first order gradiometer configuration (i.e., a differential arrangement). The magnetic tracer was composed of 50 g of ferrite powder (MgFe₂O₄) homogenized in a test food. The excitation coil generated a magnetic field on the gastric region projected and the magnetized ferrite produced a secondary magnetic field that was measured by the detection coils. The electric signal produced in the detection coils was measured, amplified, filtered and registered. Although that system represented an advance in the study of gastrointestinal motility, better sensitivity and accuracy in the detection of the ferromagnetic material were still necessary.

In 1992, Miranda et al. published an article describing a biomagnetic instrumentation used to evaluate gastric emptying (Miranda JRA et al. An AC biosusceptometer to study gastric emptying. Med. Phys., 19 (2). Mar/Apr 1992, pp. 445-448). The equipment was composed of two excitation coils and two magnetic detection coils, both aligned axially. The gradiometer magnetic signal the coils measured was detected and amplified by a lock-in amplifier (i.e., a phase-sensitive amplifier); it was filtered, digitalized and archived in a personal computer. That new arrangement demonstrated sensitivity in measuring the variation of the distance between the magnetic material (e.g., the magnetic tracer) and the detection coils, making the technique quite sensitive in measuring any movement of the ferrite within the gastrointestinal (GI) tract. The system was relatively low in cost, easy to operate, relatively portable, and had a good signal to noise ratio. The instrument developed by Miranda et al. considerably improved the sensitivity previously obtained by the equipment of Benmair et al. The new system with a single sensor represented an advance in the field of alternating current biosusceptometry (i.e., AC biosusceptometry) and it was employed in a series of studies to evaluate the time of gastrointestinal transit and other parameters related to the gastrointestinal tract. A similar biomagnetic system was described by Kumar et al. in the American patent U.S. Pat. No. 5,842,986.

In 2003 Chubaci et al. developed an AC biosusceptometer with multiple sensors to acquire magnetic images. That system was constructed with two excitation coils and seven pairs of gradiometric coils for detection. A lock-in amplifier was utilized for each pair of gradiometric coils. Chubaci et al. used that system to acquire magnetic images of phantoms of different formats, including markers and magnetic tracers. In the same year, Cora et al. used the same equipment to evaluate the disintegration of coated pills in the human stomach in vitro and in vivo. The joint use of a single sensor system with multiple sensors demonstrated an excellent capacity for evaluating different parameters of the gastrointestinal tract and for applications in the area of pharmacology. That instrumentation was employed in various studies in obtaining of images of the disintegration of solid pharmaceutical forms within the GI tract.

Different techniques such as radiography and scintigraphy are used to diagnose diseases and to study parameters related to the GI tract. Those techniques are employed to evaluate, gastric emptying for example, esophageal reflux, gastrointestinal motility and to detect intestinal obstruction, etc. More specifically, the techniques can be utilized to identify, e.g., achalasia, a disorder in the motility of the esophagus. That examination is accomplished administering barium to the patient and radiographing (or “scoping”) the individual at different intervals of time to measure the quantity of barium that has still been retained in the esophagus. For some intestinal disorders, the diagnosis is made using radio-opaque markers ingested by the patient, followed by radiography one to five days after administration, to locate and determine the position of the markers. With that type of examination it is possible to detect times of orocecal transit and gastric emptying, for example. Studies utilizing radioactive techniques are also employed to identify respiratory dysfunction in children, for example; milk marked with radioactive material is administered and confirms that some respiratory problems can be caused by esophageal reflux. in that type of study, though, it is usually necessary to employ radioactive materials or X-ray techniques for the purpose of attaining the sensitivity necessary to obtain an accurate result. While equipment utilizing magnetization is available, such apparatus are not yet capable of producing results that are as useful as those obtained utilizing techniques that involve ionizing radiation. In spite of the good results obtained, present scintigraphic equipment is generally large, heavy and involves substantially elevated costs. The use of radiation requires such apparatus to be operated by personnel with specific training in the handling of radioactive materials and the elimination of radioactive waste may be a problem. Those characteristics limit the use of such equipment to large hospitals and research institutions.

The detection of certain gastrointestinal disorders, obstructions, etc., can be critical to the goal of saving the life of a patient, and such detection must be accomplished within a maximum period of time in order to safely keep the patient alive. Doctors and patients that need such information can benefit by the availability of an apparatus constructed so that it does not require radioactive materials, it is portable, or relatively portable, and of a size that allows its installation in small medical clinics as well as in hospitals and research institutions. Apparatus such as those developed by Benmair, Miranda and others can be very useful and can be made available in hospitals, clinics and medical offices. However, such equipment depends on the use of lock-in amplifiers to detect the magnetic signals, principally for equipment with multiple sensors, and the cost of such amplifiers is prohibitive. For example, a Stanford Research Systems, USA, Model SR830DSP lock-in amplifier costs approximately US$ 4,950.00 (priced in dollars) and the Benmair and Miranda equipment needs a lock-in amplifier for each channel. An apparatus with 36 channels, for example, would cost approximately US$ 178,200.00. That elevated cost makes the technique of little interest in comparison to present equipment.

At the present time, the health area needs equipment with a good cost/benefit ratio, equipment with the sensitivity to be employed in different studies and diagnostic procedures in regard to parameters related to the gastrointestinal tract in hospitals, clinics and other health services.

### SUMMARY OF THE INVENTION

The present invention is in regard to an apparatus for the detection and measurement of the magnetic susceptibility of human or animal tissue, or of ferromagnetic material within such a tissue or organ. In its various aspects, the apparatus comprises at least one excitation device to apply an alternating current magnetic field to the tissue, at least one sensor to detect the response to the magnetic field applied, at least one tension converter to convert the signal—detected by the magnetometer—from alternating to direct current (i.e., converting from AC to DC), where the DC current can be digitalized and sent to a computerized system for analysis; where the converter is of the TRUE RMS to DC type and the computer is employed to process and analyze the signal of the TRUE RMS to DC converter.

In its various aspects, the device may also include a signal multiplexer to capture the signals of various magnetometer sensors and apply them in one single AC to DC tension converter. In the various aspects of the invention, the magnetic excitation devices may contain three magnetic excitation coils and a sensor or sensors to detect the response of the magnetic field may have one, two or three axes of detection. In an alternative configuration, the apparatus, with at least one detector and reference sensor, may be associated with, at least, one magnetic excitation device and aligned in a coplanar manner.

The invention refers to a device for the detection of a magnetic field and/or the measurement of magnetic susceptibility of human or animal tissue, or of the presence of magnetic material within a tissue or organ. The device is made up of at least one excitation device to generate a magnetic field on the tissue or organ, at least one sensor to detect the response to the magnetic field, at least one multiplexer to direct the signal of a matrix of sensors for at least one AC to DC tension converter and, at least, one tension converter to convert the response of the magnetic field detected by the magnetometer sensors from AC to DC. The output signal of the instrumentation can be filtered, digitalized and sent to a computer to be analyzed using different types of processing tools.

### BRIEF DESCRIPTION OF THE DESIGNS

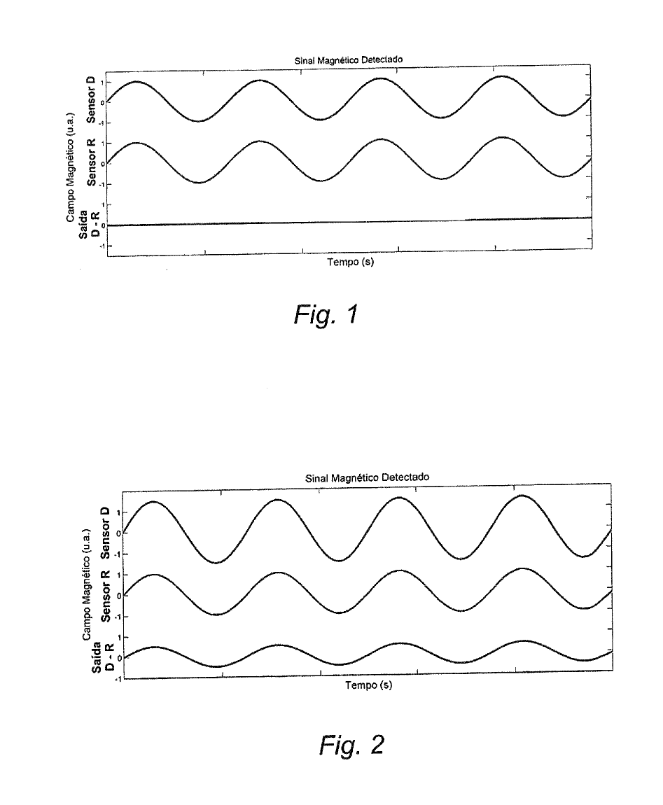

FIG. 1 illustrates the 10 kHz alternating current magnetic field generated by the magnetic excitation coils and measured by the detector sensor (Sensor D) and reference sensor (Sensor R). The gradiometric output (S=D-R) is equal to zero when there is no ferromagnetic material close to the sensors.

FIG. 2 illustrates the magnetic field detected by the sensors when there is ferromagnetic material close to the sensors. The amplitude of the detected 10 kHz signal is amplified due to the presence of the material on the detector sensor and the magnetic field measured by the sensor of reference remains unchanged. The gradiometric output (S=D-R) is equal to the contribution of the magnetic field generated by the material.

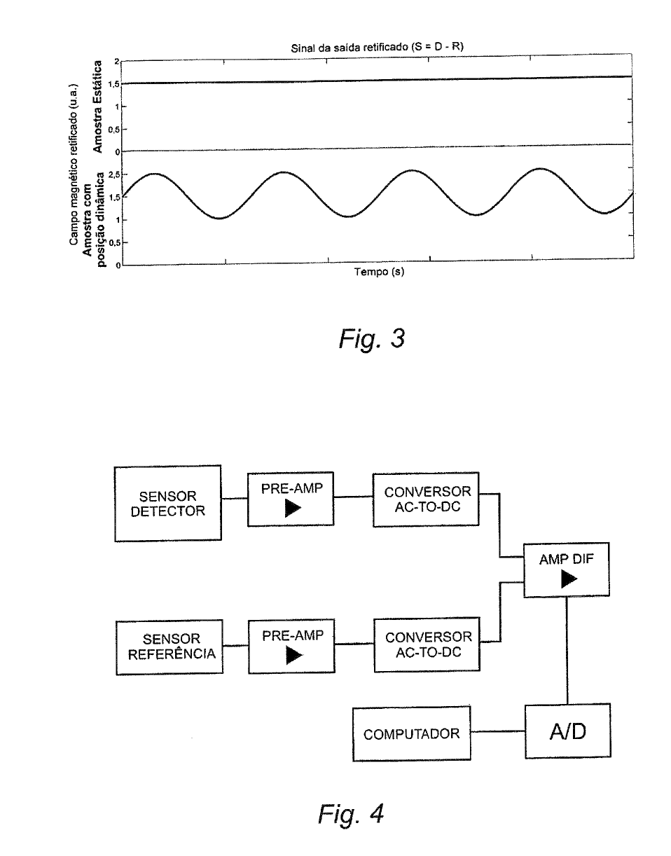

FIG. 3 shows the rectified output (S=D-R) values, given in values of RMS. The upper part of the figure shows the signal for a magnetic sample positioned in a static manner on the detector sensor. In the lower part the signal is for a sample being brought into proximity and removed in a uniform and synchronous manner. When the magnetic material is close to the detector sensor the amplitude of the signal is greater; when the material is moved further away the signal is less. That is an example of how gastric motility can be detected by the present invention.

FIG. 4 illustrates a simplified block diagram of the present invention using a TRUE RMS to DC tension converter.

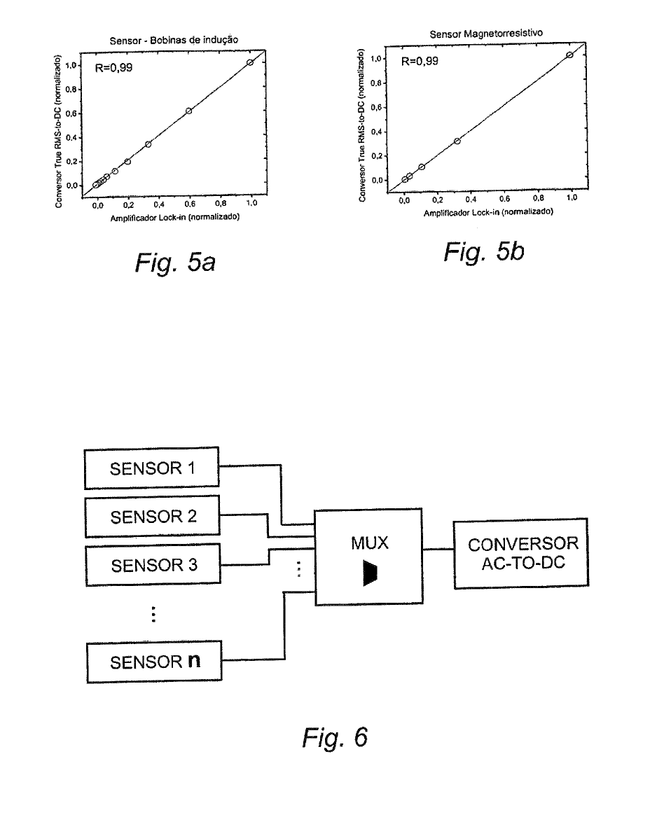

FIG. 5a shows the correlation between the TRUE RMS to DC tension converter and the lock-in amplifier when employed in an AC biosusceptometry device that uses magnetic induction coils as field sensors. The correlation obtained between the techniques was R=0.99.

FIG. 5b shows the correlation between the TRUE RMS to DC tension converter and the lock-in amplifier when employed in an AC biosusceptometry device that uses magnetoresistive sensors as field sensors. The correlation obtained between the techniques was R=0.99.

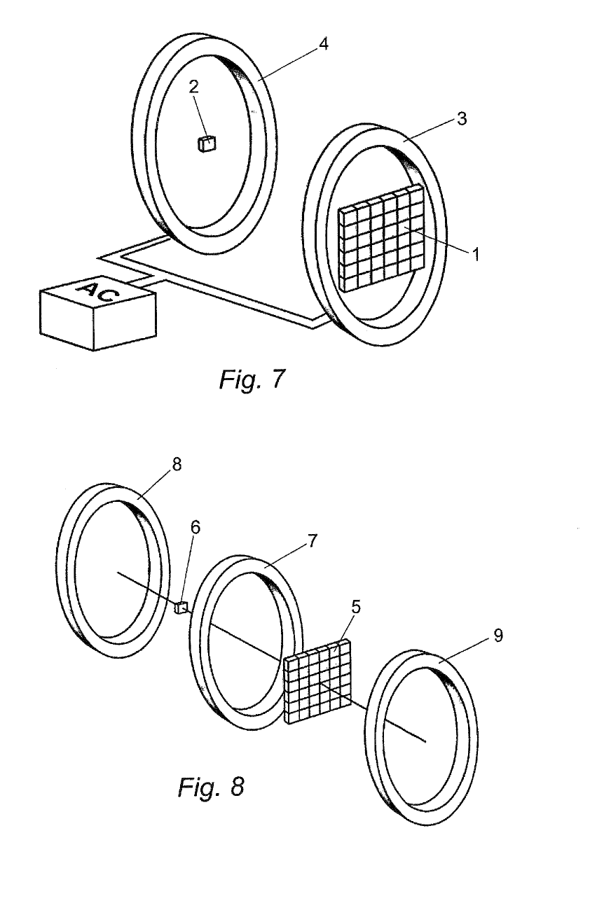

FIG. 6 illustrates a simplified block diagram of the present invention utilizing a signal multiplexer device.

FIG. 7 illustrates a simplified schematic of the present invention with a matrix with 36 detector sensor channels and a single sensor of reference. Where (1) is the matrix of magnetic sensors (36 channels), (2) is the sensor of reference and (3 and 4) are the magnetic excitation coils.

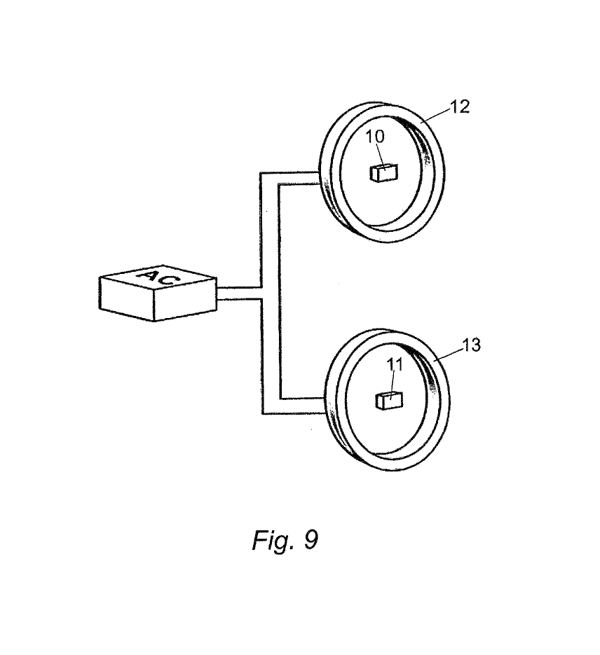

FIG. 8 illustrates the present invention using a magnetic excitation system with three induction coils. Where (5) is the matrix of magnetic sensors (36 channels), (6) is the sensor of reference and (7, 8 and 9) are the magnetic excitation coils.

FIG. 9 illustrates the present invention in an alternative geometric configuration referred to as a coplanar arrangement. Where (10) is the detector sensor, (11) is the sensor of reference and (12 and 13) are the magnetic excitation coils.

### DETAILED DESCRIPTION OF THE INVENTION

The invention comprises improvement of existing technology for the measuring of magnetic susceptibility. The improvement consists of replacing the lock-in amplifier that is commonly used in the present technology with AC to DC tension converters of the true root means square (RMS to DC) type. The advances attained are related to improving the results of the magnetic detection and to an significant cost reduction (e.g., 500 percent), the expressive results of the present invention may be employed in the equipment described by Miranda et al. (Med. Phys., 19 [2], Mar/Apr 1992, pp. 445-448) and by Kumar et al. in the American patents U.S. Pat. No. 5,842,986 and U.S. Pat. No. 6,208,884. The invention also comprises parts that include an excitation device to apply a magnetic field to a tissue or organ, to at least on sensor to detect the response of the magnetic field; to at least one converter of tension to convert the AC response detected by the sensors to DC, which can be transmitted to a computer system for analysis. Where the tension converter comprises a TRUE RMS to DC converter but is not limited to that alone, and the computer system comprises a computer and methods for the analysis and processing of signals.

AC biosusceptometry has been used in the health area for the detection and measurement of parameters related to gastrointestinal tract. The results obtained in that research are quite significant and present optimal perspectives. AC biosusceptometry equipment employs the lock-in amplifier for its functioning; the device is also known as a sensitive phase detector and it is used to detect the electromotive force (tension) measured by magnetic sensors. The signal measured is locked into a frequency and phase specified by a sinusoid signal of reference, which in this case is related to the alternating current of magnetic excitation. That method of detection is very effective for the reduction of undesirable signals, such as environmental noise. However, that type of amplifier can have a value on the order of thousands of dollars, making its use prohibitive in a multi-channel AC biosusceptometry system. The present true RMS to DC tension converters measure the average quadratic value of the tension of an AC signal furnishing a DC signal in proportion to the RMS value. In addition, these modern tension converters perform well, have an optimal signal to noise ratio, low cost and are encapsulated in chips of reduced size. These converters were utilized by the inventors to develop an AC magnetic Biosusceptometry instrument of excellent sensitivity and to reduce the cost of manufacture of the device to a fraction of the cost of the equipment produced with lock-in amplifiers. For example, the TRUE RMS converter model AD637 (Analog Device Inc., USA) can be purchased for US $11.01 (value in dollars), converter model AD536 for US $6.18 and AD536 for US $7.87. For a device with 36 detector sensors and one sensor of reference, that represents a cost of US $407.37, the price of 37 TRUE RMS model AD637 converters, while the cost of a 36-channel system utilizing lock-in amplifiers may go as high as US $178,200.00 merely for the acquisition of the amplifiers. The inventors' improvement of existing technology therefore results in a device that can be within the budget of small clinics and medical offices, as well as of large hospital centers and research institutions. That, consequently, can result in a greater availability of diagnoses of diseases related to the gastrointestinal tract for the patients and in a greater dissemination of technology applicable to, e.g., gastroenterology, pharmacology and research in medical clinics.

The function of this technology is based on the magnetic response generated by ferromagnetic (or paramagnetic) material when confronted by an externally induced alternating current magnetic field (e.g., 10 kHz). When there is no material present in proximity to the sensors the fields detected by the detector sensor (Sensor D) and by the reference sensor (Sensor R) are equal and the gradiometric output of the system is theoretically equal to zero (i.e., Output=Sensor D-Sensor R). FIG. 1 shows the magnetic excitation field detected by the sensors with frequency, e.g., 10 kHz, and the null gradiometric output.

When the magnetic material (ferromagnetic sample) is placed in proximity to the detector sensor, the magnetic field in that region increases due to the presence of the material, generating a signal that is captured by the detector sensor. FIG. 2 illustrates the signal increase measured by the detector sensor. In that case, the gradiometric output of the system is equal to the magnetic contribution generated by the sample positioned close to the sensors.

The variation of the position ferromagnetic material close to the sensor modifies the amplitude of the gradiometric output. For small distances the signal presents greater amplitude and for longer distances the amplitude falls rapidly. Due to that characteristic of response the intensity of the signal suffers variations with any movement, even movement in millimeters. In that manner, e.g., the gastric contraction activity (GCA) molds the gradiometric signal generated by a magnetic marker placed in the interior of the stomach. FIG. 3 shows the value of the amplitude (or RMS value of the signal) for a static marker or magnetic tracer placed close to the sensor and in movement cadenced to the approximation and distancing, e.g., simulating human GCA.

In the past the lock-in amplifier with appropriate rejection mode for measuring the amplitude of the AC gradiometric signal (illustrated in FIG. 2) and converted it into DC (illustrated in FIG. 3), was the most used option. The DC output was locked into the excitation frequency (i.e., 10 kHz) and the amplitude of the signal was recorded by the amplifier. Although such amplifiers offer optimal results, they do have the disadvantage of being large and costly. The use of multiple channels of detection would require multiple banks of amplifiers, causing an increase in the dimensions of the instrumentation and elevating the cost of manufacture. The inventors discovered that the use of a simple true RMS to DC tension converter chip—coupled to each detector channel—obtains the same performance as the instrumentation with the lock-in amplifier and, in some cases, offers even better results. The employment of this type of converter also has the advantage of decreasing the cost of instrumentation by approximately 500 percent.

In the present invention true RMS to DC tension converters were employed to measure the AC signal of each sensor (detector and reference) and the DC signal was later replaced, using a single instrumentation amplifier. FIG. 4 shows a simplified diagram of the electronic circuit developed as part of the present invention. In an alternative configuration, the converter may be employed to measure the RMS value of the AC current in the gradiometric output of the sensors.

True RMS to DC tension converters are widely available and commercially inexpensive. The replacement of lock-in amplifiers by this type of convertor results in a biomagnetic instrumentation extremely feasible for different types of applications, principally for applications related to the GI tract. Among the innumerable advantages presented by AC biosusceptometry implemented with true RMS to DC converters we can point out its extremely low cost, its reduced dimensions, the absence of ionizing radiation, its portability and its non-invasive nature.

FIG. 5 shows the correlation between the signals from the same device utilizing a true RMS to DC converter and using a lock-in amplifier. These tests were performed using a system with magnetic induction coils as detectors (FIG. 5a) and another system using magnetoresistive sensors (FIG. 5b), both systems utilizing cylindrical coils for the magnetic excitation. The sensors were aligned axially in a first order gradiometric configuration. In the tests carried out, a small cylindrical magnetic marker was constructed with 1 g of ferrite powder homogenized with 0.5 g of cellulose pressed into a pill form (10 mm in diameter and 8 mm high). The pill was axially distanced along the sensors' axis of detection and the magnetic field was measured at each distance. The instrumentation signals were taken with the true RMS to DC converter solution and with the traditional configuration using the lock-in amplifier. Tests for both instrumentations were conducted under identical conditions, merely substituting a true RMS to DC converter for the lock-in amplifier. The result of the correlation between the tension converter and the lock-in amplifier was R=0.99 for both types of sensors (induction roils and magnetoresistor).

The present invention also relates to a device and a method in which a true RMS to DC converter is associated with at least one signal multiplexer. That is, in an alternative configuration, a true RMS to DC converter can be associated with a signal multiplexer. That configuration can be employed to reduce the number of converters to a single true RMS to DC converter. In another aspect, the signal multiplexer can be used to improve the detection of Biosusceptometry devices such as those that use lock-in amplifiers and field programmable gate arrays (FPGA), among other types of analog or digital tension converters.

The multiplexer captures the signals from the magnetic sensors and sends them to a single true RMS to DC converter; the signal is rectified by the converter, digitalized and acquired by a personal computer. As the multiplexing velocity is high (e.g., 0.001 seconds per channel), the final signal can be sampled with a high rate of acquisition without prejudicing any application of the techniques in acquiring signals in vivo. FIG. 6 shows a simplified schematic of the employment of the signal multiplexer in AC biosusceptometry.

The use of the signal multiplexer reduces the number of AC to DC tension conversions in the instrumentation and that allows the use of more costly converters, including but not limited to, lock-in amplifiers and field programmable gate arrays (FPGA). That solution allows the construction of equipment even lower in cost, reducing still further the operational cost of the device by means of the reduction of the number of converters employed.

Devices incorporating true RMS to DC converters as in the present invention can be used to measure physiological parameters in human, as well as in small, medium and large animal, gastrointestinal tracts because the measurements are taken with magnetometers to detect magnetic markers or tracers at environmental temperature. Magnetometers can measure magnetic field variation and/or magnetic susceptibility. Magnetometers that can be utilized in the present invention include, but are not limited to, anisotropic magnetoresistive (AMR) sensors, fluxgate meters, induction coils, atomic and spin-exchange relaxation free (SERF) sensors. In another aspect of the invention, the magnetometers can include induction coils coupled with giant magnetoresistive (GMR) sensors and maintained at liquid nitrogen temperatures. Magnetometers include sensors with three axes (x, y and z), two axes (x and y) and a single magnetic detection axis. Magnetic markers and/or tracers that may be used include, but are not limited to, ferrite, magnetite and permanent (e.g., neodymium-NdFeB) magnets. Magnetic excitation coil dimensions can be determined to optimize the magnetic field applied to the sensors and the region of interest, for the purpose of maximizing the response of the ferromagnetic material, e.g., located within the gastrointestinal tract, and to minimize the non-homogeneity of the magnetic excitation field. The present invention can even be constructed using a gradiometric system of the first order (i.e., a differential arrangement) to minimize the noise caused by possible fluctuations of the magnetic field on the magnetometers. In such a system the magnetic field and the noise affecting the detector sensors can be cancelled out by utilizing one or more sensors of reference. In one possible configuration, a multi-channel system with (e.g., 36 channels) various sensors can use a single sensor of reference. FIG. 7 shows a simplified schematic for instrumentation with 36 detector sensors and a single sensor of reference. The AC signal measured by each magnetometer is converted to DC using a true RMS to DC converter. The gradiometric output signals of the instrumentation are digitalized by an analog to digital converter and sent to a personal computer where they can be processed in real time or stored for future analysis.

In an alternative configuration, the instrumentation can employ a third excitation coil (FIG. 8). The third excitation coil is employed to augment the magnetic field applied to the sample studied and, in that manner, to increase the sensitivity of the instrumentation in detecting materials (e.g., magnetic markers and tracers) at greater distances. In that configuration the body with magnetic material to be studied must be positioned between the sensor matrix (5) and the third coil (9).

In one of the applications of the present invention, the equipment can be used to measure the magnetic susceptibility of magnetic tracers and/or markers distributed throughout the gastrointestinal tract. The functioning principal of the instrumentation can be explained in a summary manner in that case: the device applies an AC magnetic field by means of the excitation coils; that field induces the magnetization of the ferromagnetic material (e.g., tracer and/or magnetic marker constructed on the basis of ferrite). A small magnetic field is produced by the magnetization of the material and it is detected by the magnetic sensors. The magnetization of the material is in proportion to the intensity of the magnetic field applied, the susceptibility of the material and the distance between the sensor and the magnetized material. As the signal measured by the magnetometers is strongly dependent on the distance to the magnetized material, any movement of the material can be detected and measured. In that manner, the magnetized material can be accompanied in the interior of the gastrointestinal tract, thus obtaining parameters of motility, time of and gastric emptying, as well as the action of pharmaceutical agents on those parameters.

The present invention can analyze the different characteristics of the GI tract by means of the analysis of the signals molded by its motor activity or through analysis of the magnetic images obtained by a multi-channel (e.g., 36 channel) biomagnetic system. The two forms of analysis can be utilized in research or for purposes of diagnosis of GI tract diseases. Magnetic images, in particular, can be used, e.g., to investigate the distribution of the material in the interior of the organ and to evaluate the anatomy or mechanical characteristics of the GI tract in humans and animals.

One example of the device developed in the present invention comprises two induction coils and 36 magnetic field sensors used as detectors plus one sensor of reference. The sensors used constitute an axis of sensitivity. The excitation coils produce an AC magnetic field (10 kHz) and the magnetometers are used to measure the excitation magnetic field and its variation, caused by the presence of ferromagnetic material (i.e., magnetic tracer and/or marker).

The detector sensors were distributed in a square matrix 6×6. The distance between the magnetometers was 12 mm from center to center. The matrix of sensors was positioned in the center of one excitation coil and the sensor of reference was positioned in the center of the other coil. The pairs of sensors and coils were aligned axially and fixed at a distance of 150 mm; that distance is referred to as the base line. FIG. 7 shows a simplified schematic of the instrumentation.

The excitation/detection pair located furthest from the sample to be studied acts as the reference and the 36 sensors act as detectors of the variation of the magnetic field caused by the magnetized sample (e.g., ferrite). The gradiometric configuration of the first order was established in that instrumentation with the assistance of high performance, low cost instrumentation amplifiers. That gradiometric configuration is utilized to reduce magnetic and electronic noise, which is generally equal and random across the sensors.

The alternating current magnetic field signals measured by the sensors are amplified using instrumentation amplifiers. The amplified signal of each sensor is sent to a true RMS to DC tension converter. The converter transforms alternating to direct current maintaining the RMS voltage characteristics of each sensor. The different amplitudes between the signals of the sensors indicate the magnetic field amplitude each sensor detects. The correlation between the magnetic field tension and intensity can be obtained by simple calibration methods.

The rectified signals from the detector sensors are applied in the non-inverting entrance of an instrumentation amplifier. It is important to point out that in this construction each sensor used one amplifier and the same signal of reference was placed in all of them. In this configuration the output of the amplifiers furnishes an output equal to zero when there is no ferromagnetic material close to the detector sensors and a positive non-null amplitude signal that is equal to the contribution of the magnetic field produced by the proximity of the magnetic field produced by the proximity of a ferromagnetic material. That signal is free of noise and of the magnetic field generated by the excitation coils since the subtraction of the signals eliminate the excitation field, which is approximately equal across the sensors. Any difference in that field can be nullified using offset coil solutions calibrated in the sensors or in the offset calibrations of the instrumentation amplifiers.

The gradiometric output of each channel can be filtered or not, utilizing electronic analog filters the output is being connected to an analog to digital converter. The digitalized signal can then be processed utilizing different types of digitalized tools and/or it can be archived in a computer for subsequent analysis and processing. The same process can be carried out in the case of magnetic images.

In applications of the equipment in vivo the digitalized signal carries information from the organs studied, e.g., information related to esophageal (or pharyngeal) transit time and clearance, motility and gastric emptying time and colonic motility, among others. Multi-channel device applications can be devoted to the acquisition of signals as well as images of markers or tracer distributions inside the organs evaluated. For example, if the distribution of the tracer comprises the entire interior of the organ, the magnetic image obtained can be utilized to analyze the internal anatomy of the organ or any type of obstruction.

In an alternative configuration of the present invention, the sensors and excitation coils can be aligned in the same geometric plane, as illustrated in FIG. 9. This type of arrangement can be used, for example, in order to measure the pharyngeal or esophageal transit time of magnetic tracers/markers. The spatial disposition of the sensors and coils can be axial or coplanar, as shown in FIGS. 7 and 9, but they are not limited merely to those configurations. The distribution of the detector sensors can assume a square geometry, as shown in FIG. 7, or a take the form of a hexagon (honeycomb), or any other more convenient geometric form for each application.

The magnetic detection devices described here can also be useful for non-medical purposes. An example of that type of application is in the localization of metallic bodies in humans and animals, as in security screening, where the detection and localization of metallic objects are desired. Due to the characteristics of the electronics and physical principles involved in the present invention, the devices are relatively portable, have a high sensitivity for that type of application and can be produced at effectively reduced costs by employing true RMS converters. Such devices can be adequate for use in schools, in public transportation facilities and other installations where detection with magnetic susceptibility can be useful. In such applications the equipment can be employed in the detection of magnetic masses by means of audible or visible alarms or quantitative measurements visualized in digital displays. Another aspect that can be involved in that type of investigation is the acquisition and analysis of magnetic images that the present technology can offer.

1. An apparatus to detect and measure the susceptibility of tissues in humans or animals and of objects with magnetic properties in their interior, said apparatus comprising at least one excitation device for the application of a magnetic field to a region of interest; at least one sensor for detecting a response of the magnetic field; at least one AC to DC tension converter for converting the magnetic field detected by the at least one sensor to a DC value that is transmitted to a computer processor to analyze the response; and, a computer processor for the processing of the signals and images obtained by the sensors; where the aforesaid AC to DC tension converter comprises a true RMS to DC tension converter; and a computer processor to analyze the true RMS to DC converter signal.

2. The apparatus in accordance with claim 1 wherein the detector sensors and sensors of reference are configured in a gradiometric manner.

3. The apparatus in accordance with claim 1 further comprising a signal multiplexing device.

4. The apparatus in accordance with claim 1 wherein the excitation device comprises three magnetic excitation coils.

5. The apparatus in accordance with claim 1 wherein the magnetic sensors provide one, two or three axes of detection.

6. The apparatus in accordance with claim 1 wherein the sensors and excitation coils can be aligned in a coplanar manner.

7. A method for detecting and measuring the magnetic susceptibility of human or animal tissue, or the presence of ferromagnetic material within the tissue, which comprises presenting at least one excitation device for the application of a magnetic field to a region of interest; at least one sensor to detect a response of the magnetic field; at least one multiplexing device to capture and redirect a signal of a matrix of sensors to at least one AC to DC tension converter; at least one AC to DC tension converter to convert the magnetic field detected by the sensors to a DC value, for transmission to a computer processor to analyze the response, analyze the converter signal, and process the signals and images obtained by the sensors.
